(19) United States
(12) Patent Application Publication
(10) Pub. No.: US 2018/0079422 A1
(43) Pub. Date: Mar. 22, 2018

(54) ACTIVE TRAFFIC PARTICIPANT

(71) Applicant: GM GLOBAL TECHNOLOGY OPERATIONS LLC, Detroit, MI (US)

(72) Inventor: Benjamin WEINSTEIN-RAUN, San Francisco, CA (US)

(73) Assignee: GM GLOBAL TECHNOLOGY OPERATIONS LLC, Detroit, MI (US)

(21) Appl. No.: 15/822,910

(22) Filed: Nov. 27, 2017

(51) Int. Cl. B60W 40/04; B60W 30/10

(52) U.S. Cl. CPC B60W 40/04; B60W 2050/0002; B60W 30/10

(57) ABSTRACT

Systems and method are provided for assessing a target vehicle in proximity to a host vehicle. In one example, a method includes identifying the target vehicle in proximity to the host vehicle; obtaining sensor data, from one or more sensors onboard the host vehicle, pertaining to one or more characteristics of the target vehicle; and assessing a state of the target vehicle, via a processor, via a dynamic Bayesian network, using the sensor data as inputs for the dynamic Bayesian network.

### TECHNICAL FIELD

The present disclosure generally relates to vehicles, and more particularly relates to systems and methods for a vehicle's assessment of other vehicles in proximity thereto.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While autonomous vehicles offer many potential advantages over traditional vehicles, in certain circumstances it may be desirable for improved movement of autonomous vehicles, for example in response to another vehicle.

Accordingly, it is desirable to provide systems and methods for operation of vehicles, such as autonomous vehicles, including assessments pertaining to one or more other vehicles in proximity thereto. Furthermore, other desirable features and characteristics of the present disclosure will become apparent from the subsequent detailed description and the appended claims, taken in conjunction with the accompanying drawings and the foregoing technical field and background.

### SUMMARY

In accordance with exemplary embodiments, a method for assessing a target vehicle in proximity to a host vehicle is provided. In certain embodiments, the method includes (i) identifying the target vehicle in proximity to the host vehicle; (ii) obtaining sensor data, from one or more sensors onboard the host vehicle, pertaining to one or more characteristics of the target vehicle; and (iii) assessing a state of the target vehicle, via a processor, via a dynamic Bayesian network, using the sensor data as inputs for the dynamic Bayesian network.

Also in certain embodiments, the step of assessing the state of the target vehicle includes assessing the state of the target vehicle as active or inactive based on a dynamic Bayesian network, using the sensor data in the dynamic Bayesian network, wherein the state of the target vehicle is characterized as: (i) active, if the target vehicle is attempting to travel to a location; and (ii) inactive, if the target vehicle is not attempting to travel to a location.

Also in certain embodiments, each of the steps is performed as part of operation of an autonomous vehicle.

Also in certain embodiments, the step of assessing the state of the target vehicle includes assessing a state of the target vehicle, via a processor, via the dynamic Bayesian network that includes a plurality of percept nodes, a plurality of dynamic nodes, a plurality of intermediate nodes, and an activity node representing the state of the target vehicle, using the sensor data as inputs for the dynamic Bayesian network.

Also in certain embodiments, the step of assessing the state of the target vehicle includes: (i) generating percept values for the percept nodes pertaining to observed values for the sensor data; (ii) determining distributions for each of the nodes, the distribution for each respective node including one or more conditional probabilities for the respective node in relation to one or more other nodes of the dynamic Bayesian network pertaining to the sensor data; and (iii) assessing the state of the target vehicle using the percept values and the distributions.

Also in certain embodiments, the percept values are generated based on one or more probabilistic measures provided via one or more sensors of the host vehicle.

Also in certain embodiments, the step of assessing the target vehicle further includes: (i) assigning current dynamic values based at least in part on respective prior dynamic values and respective percept values; (ii) wherein the step of determining distributions includes, for at least some of the nodes, determining the distributions based also at least in part on the current dynamic values.

In other exemplary embodiments, a system for assessing a target vehicle in proximity to a host vehicle is provided. In certain embodiments, the system includes a detection module and a processor. The detection module is configured to at least facilitate: (i) detecting the target vehicle in proximity to the host vehicle; and (ii) obtaining sensor data, from one or more sensors onboard the host vehicle, pertaining to one or more characteristics of the target vehicle. The processing module is coupled to the detection module and is configured to, by a processor, at least facilitate assessing a state of the target vehicle via a dynamic Bayesian network, using the sensor data as inputs for the dynamic Bayesian network.

Also in certain embodiments, the processing module is configured to at least facilitate characterizing the state of the target vehicle, using the sensor data and the dynamic Bayesian network, as: (i) active, if the target vehicle is attempting to travel to a location; and (ii) inactive, if the target vehicle is not attempting to travel to a location.

Also in certain embodiments, the system is implemented as part of an autonomous vehicle.

Also in certain embodiments, the dynamic Bayesian network includes a plurality of percept nodes, a plurality of dynamic nodes, a plurality of intermediate nodes, and an activity node representing the state of the target vehicle.

Also in certain embodiments, the processing module is configured to at least facilitate: (i) generating percept values for the percept nodes pertaining to observed values for the sensor data; (ii) determining distributions for each of the nodes, the distribution for each respective node including one or more conditional probabilities for the respective node in relation to one or more other nodes of the dynamic Bayesian network pertaining to the sensor data; and (iii) assessing the state of the target vehicle using the percept values and the distributions.

Also in certain embodiments, the processing module is configured to at least facilitate generating the percept values based on one or more probabilistic measures provided via one or more sensors of the host vehicle.

Also in certain embodiments, the processing module is configured to at least facilitate: (i) assigning current dynamic values based at least in part on respective prior dynamic values and respective percept values; and (ii) determining the distributions, for at least one of the nodes, based also at least in part on the current dynamic values.

In other exemplary embodiments, an autonomous vehicle is provided. In certain embodiments, the autonomous vehicle includes an autonomous drive system; a plurality of sensors; and a processor. The autonomous drive system is configured to operate the autonomous vehicle based on instructions that are based at least in part on a state of a target vehicle in proximity to the autonomous vehicle. The plurality of sensors are configured to obtain sensor data pertaining to one or more characteristics of a target vehicle in proximity to the autonomous vehicle. The processor is coupled to the plurality of the sensors and to the autonomous drive system, and is configured to at least facilitate: (i) assessing a state of the target vehicle via a dynamic Bayesian network, using the sensor data as inputs for the dynamic Bayesian network; and (ii) providing the instructions to the autonomous drive system based at least in part on the assessed state of the target vehicle.

Also in one embodiment, the processor is configured to at least facilitate characterizing the state of the target vehicle, using the sensor data and the dynamic Bayesian network, as: (i) active, if the target vehicle is attempting to travel to a location; and (ii) inactive, if the target vehicle is not attempting to travel to a location.

Also in one embodiment, the dynamic Bayesian network includes a plurality of percept nodes, a plurality of dynamic nodes, a plurality of intermediate nodes, and an activity node representing the state of the target vehicle.

Also in one embodiment, the processor is configured to at least facilitate: (i) generating percept values for the percept nodes pertaining to observed values for the sensor data; (ii) determining distributions for each of the nodes, the distribution for each respective node including one or more conditional probabilities for the respective node in relation to one or more other nodes of the dynamic Bayesian network pertaining to the sensor data; and (iii) assessing the state of the target vehicle using the percept values and the distributions.

Also in one embodiment, wherein the processor is configured to at least facilitate generating the percept values based on one or more probabilistic measures provided via one or more sensors of the host vehicle.

Also in one embodiment, the processor is configured to at least facilitate: assigning current dynamic values based at least in part on respective prior dynamic values and respective percept values; and determining the distributions, for at least one of the nodes, based also at least in part on the current dynamic values.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a target assessment system, in accordance with various embodiments;

FIG. 2 is a functional block diagram illustrating a transportation system having one or more vehicles as shown in FIG. 1, in accordance with various embodiments;

FIG. 3 is functional block diagram illustrating an autonomous driving system (ADS) having a target assessment system associated with the vehicle of FIG. 1, in accordance with various embodiments;

FIG. 4 is a functional block diagram illustrating the target assessment system, in accordance with various embodiments;

FIG. 5 is a schematic diagram of the vehicle 10 on a roadway proximate a target vehicle, in accordance with exemplary embodiments;

FIG. 6 is a flowchart for a control process for a vehicle assessing a target vehicle, in accordance with various embodiments.

FIG. 7 is a Bayesian flow diagram that can be implemented in connection with the control process of FIG. 6 and the vehicle and systems of FIGS. 1-5, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

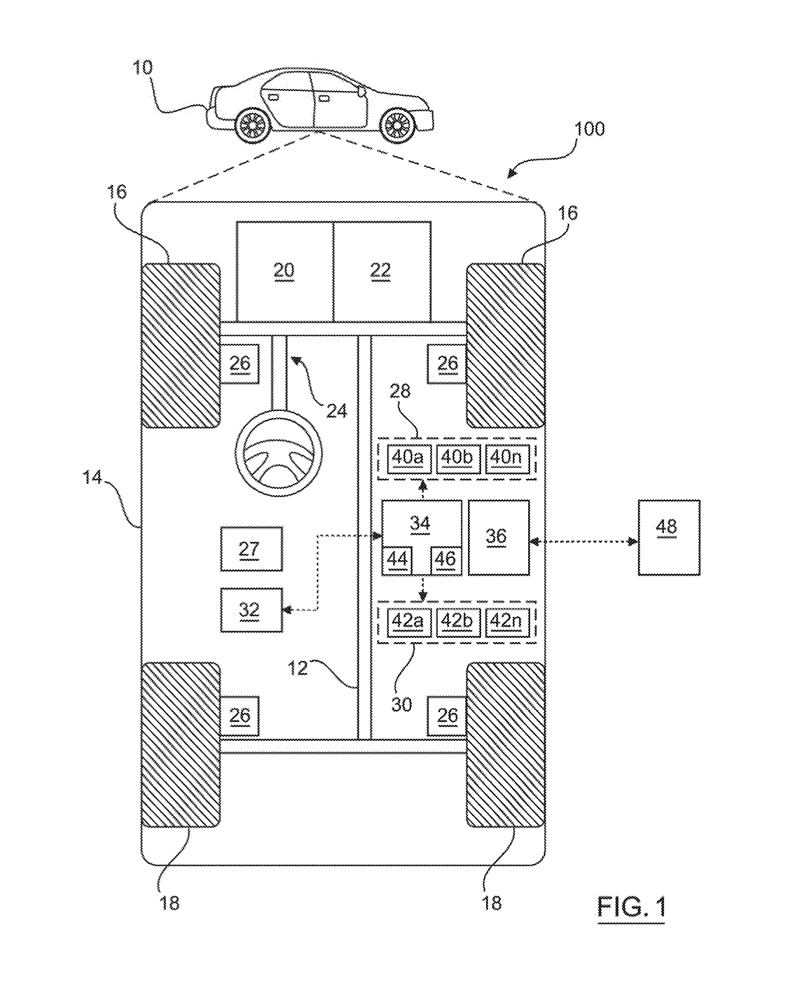

With reference to FIG. 1, a target assessment system shown generally as 100 is associated with a vehicle 10 (also referred to herein as a “host vehicle”) in accordance with various embodiments. In general, the target assessment system (or simply “system”) 100 provides assessments of target vehicles that are detected in proximity to the vehicle 10 (for example, as to whether the target vehicle is active or inactive), for use in coordinating of appropriate responses from the vehicle 10 based on the assessments. For example, in various embodiments, the vehicle 10 may alter its path differently based on whether the target vehicle is active (e.g., if the target vehicle is currently being driven, is waiting at a traffic light, is in traffic, and so on) or inactive (e.g., when the target vehicle is parked by the side of the road or in a parking lot, waiting at a bus stop, stopped to make a delivery, double parked, and so on).

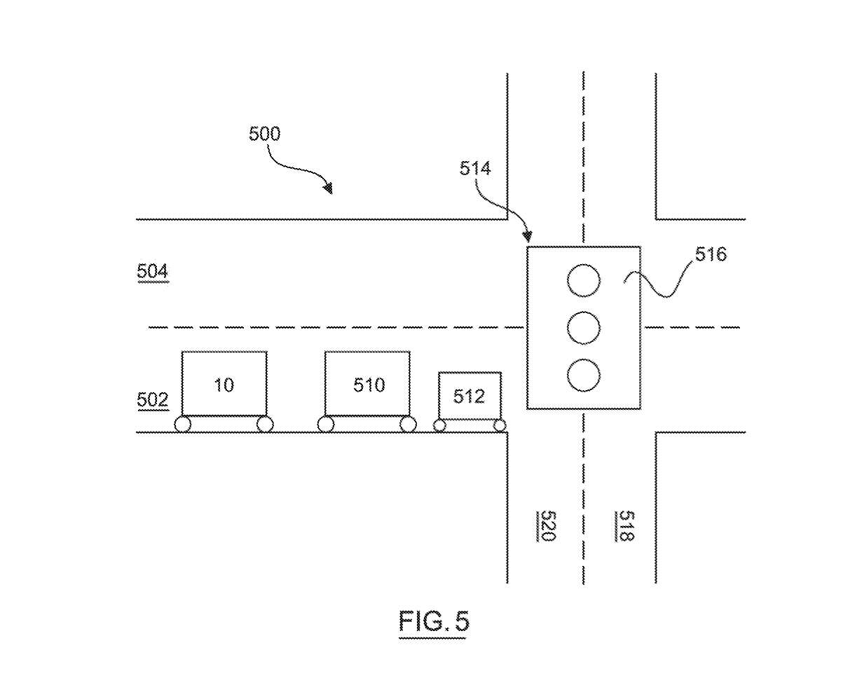

In various embodiments, as used throughout this Application, unless as otherwise noted, a target vehicle is “active” if the target vehicle is considered to be an “active traffic participant” (ATP). In various embodiment, the target vehicle (e.g., vehicles 510 and/or 512 of FIG. 5, discussed further below) can be active regardless of whether the target vehicle is fully autonomous vehicle, a partially autonomous vehicle, and/or a traditional (e.g., non-autonomous) vehicle. Also in various embodiments, a target vehicle is considered to be active if the target vehicle is determined to be participating in traffic, and inactive if the target vehicle is determined to be not participating in traffic.

In certain embodiments, a target vehicle is considered to be participating in traffic if the target vehicle is moving. Also in certain embodiments, the target vehicle is also considered to be participating in traffic if the target vehicle is stopped, but a determination has been made that the target vehicle would be moving if the target vehicle had freedom of movement, such as if the target vehicle did not have objects (e.g., other vehicles, pedestrians, and so on) and/or other conditions (e.g., a red light, a stop sign, and so on) that serve to prevent or inhibit immediate movement of the target vehicle in an intended path of travel for the target vehicle. Conversely, in certain embodiments, the target vehicle is considered to be not participating in traffic if the target vehicle is stopped, and a determination has been made that the target vehicle would still not be moving even if the target vehicle had such freedom of movement, then the target vehicle is determined to be inactive. In other words, in various, embodiments, the target vehicle is considered to be not participating in traffic if the target vehicle is stopped and would not be presently moving, regardless of whether the target vehicle had freedom of movement, for example regardless of whether the object or conditions preventing or inhibiting movement of the target vehicle in an intended path of travel were present.

In certain embodiments, a target vehicle is considered to be participating in traffic if it is determined that the target vehicle is either currently moving or is likely to be moving within a predetermined amount of time (e.g., within a number of seconds or within a few minutes, in certain embodiments). Conversely, in certain embodiments, a target vehicle is considered to be not participating in traffic if it is determined that the target vehicle is currently not moving and is unlikely to be moving within a predetermined amount of time (e.g., within a number of seconds or within a few minutes, in certain embodiments).

For example, in certain embodiments, the target vehicle is determined to be participating in traffic if the target vehicle is either currently moving, or if the target vehicle is waiting solely roadway-related conditions (e.g., a waiting for a stop light to turn green, waiting to complete a stop at a stop sign, waiting for a police car, ambulance, fire truck, or the like to drive by, waiting for one or more other vehicles and/or objects to move out of the way of the target vehicle's intended path, and so on) before the target vehicle moves. Conversely, in certain embodiments, the target vehicle is determined to be not participating in traffic if the target vehicle is not moving, and the target vehicle is waiting on one or more non-roadway-related conditions (e.g., waiting for a delivery to be made, waiting for passengers to load onto or unload from a bus, waiting for a driver or passenger to return to the target vehicle, and so on) before the target vehicle moves.

In certain embodiments, a target vehicle is considered to be participating in traffic if it is determined that the intent of the target vehicle (and/or a driver or other operator thereof) is to move, and participant in traffic, once roadway circumstances allow (e.g., once another vehicle or other object moves out of the way of the target vehicle's intended path of travel, once a red light traffic signal turns green, and/or once the target vehicle completes a stop at a stop sign, and so on). Conversely, in certain embodiments, a target vehicle is considered to be not participating in traffic if it is determined that the intent of the target vehicle (and/or a driver or other operator thereof) is to remain stopped and to not participate in traffic for at least a predetermined amount of time (e.g., more than a few minutes or longer, in certain embodiments), regardless of whether such roadway circumstances allow.

In certain embodiments, the intent of the target vehicle (and/or its operator) may be determined based on a number of observed characteristics pertaining to the target vehicle. For example, in certain embodiments, the intent of the target vehicle (and//or its operator) may be determined based on observed characteristics (e.g., movement or non-movement) of a lead vehicle in front of the target vehicle; operation of the blinkers and/or other turn signal indicators for the target vehicle; a type of vehicle represented by the target vehicle (e.g., whether the target vehicle is a bus, delivery vehicle, or the like), whether the target vehicle is currently moving; information as to an intersection or roadway in which the target vehicle is travelling (e.g., whether a stop sign or traffic light is present, whether an emergency vehicle is travelling nearby, or whether there is an observed blockage in traffic, and if so whether the blockage in traffic is passable, and so on); and a lane position of the target vehicle (and including, for example, whether the target vehicle is pulled over, or whether the target vehicle is in a turn lane waiting to make a turn, or whether the target vehicle is in a loading zone or marked parking lot, and so on), among other possible characteristics of the target vehicle, other nearby vehicles, and/or the roadway on which the target vehicle is travelling. Also in various embodiments, such characteristics may be ascertained using sensor data from one or more sensors 40a-40n of the sensor system 28, including, by way of examples, one or more radars, lidars, global positioning systems, optical cameras, thermal cameras, ultrasonic sensors, inertial measurement units, and/or other sensors.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the target assessment system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes sensors and a suspension system.

As shown, the vehicle 10 generally includes a propulsion system 20, a transmission system 22, a steering system 24, a brake system 26, one or more user input devices 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

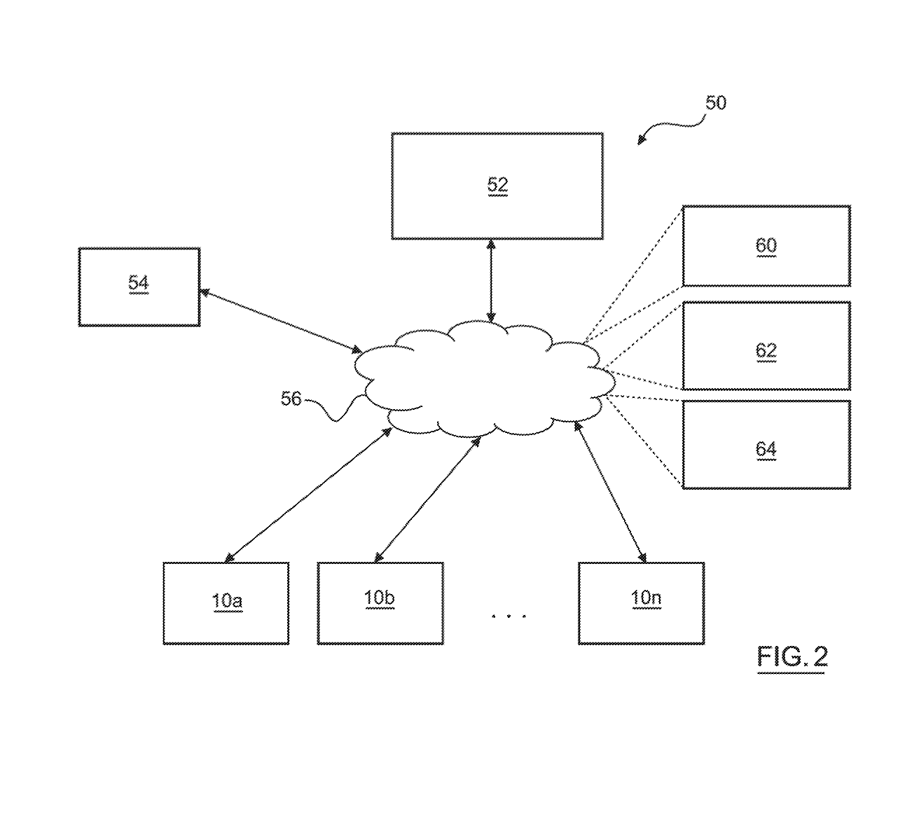

In various embodiments, one or more user input devices 27 receive inputs from one or more passengers of the vehicle 10. In various embodiments, the inputs include a desired destination of travel for the vehicle 10. In addition, in certain embodiments, the inputs may also include information from the passengers as to an identification of one or more characteristics of another vehicle (referred to herein as a target vehicle) in proximity to the vehicle and/or its surroundings (e.g., the type of vehicle, whether the target vehicle is moving, usage of the brakes for the target vehicle, use of blinkers, hazard lights, turn indicators, or other signals, a lane position of the target vehicle, a traffic intersection proximate the target vehicle, and/or one or more other vehicles in front of the target vehicle, among other possible information). In certain embodiments, one or more input devices 27 comprise an interactive touch-screen in the vehicle 10. In certain embodiments, one or more inputs devices 27 comprise a speaker for receiving audio information from the passengers. In certain other embodiments, one or more input devices 27 may comprise one or more other types of devices and/or may be coupled to a user device (e.g., smart phone and/or other electronic device) of the passengers, such as the user device 54 depicted in FIG. 2 and described further below in connection therewith).

The sensor system 28 includes one or more sensors 40a-40n that sense observable conditions of the exterior environment and/or the interior environment of the vehicle 10. The sensors 40a-40n include, but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In certain embodiments, the communication system 36 is further configured for communication between the sensor system 28, the input device 27, the actuator system 30, one or more controllers (e.g., the controller 34), and/or more other systems and/or devices (such as, by way of example, the user device 54 depicted in FIG. 2 and described further below in connection therewith). For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers (e.g., the user device 54 of FIG. 2), and/or one or more sources of remote information (e.g., GPS data, traffic information, weather information, and so on).

With reference now to FIG. 2, in various embodiments, the vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more vehicles 10a-10n as described with regard to FIG. 1. In various embodiments, the operating environment 50 (all or a part of which may correspond to entities 48 shown in FIG. 1) further includes one or more user devices 54 that communicate with the vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the vehicles 10a-10n to schedule rides, dispatch vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline vehicle 10 and/or a vehicle based remote transportation system 52. To this end, a vehicle and vehicle based remote transportation system can be modified, enhanced, or otherwise supplemented to provide the additional features described in more detail below.

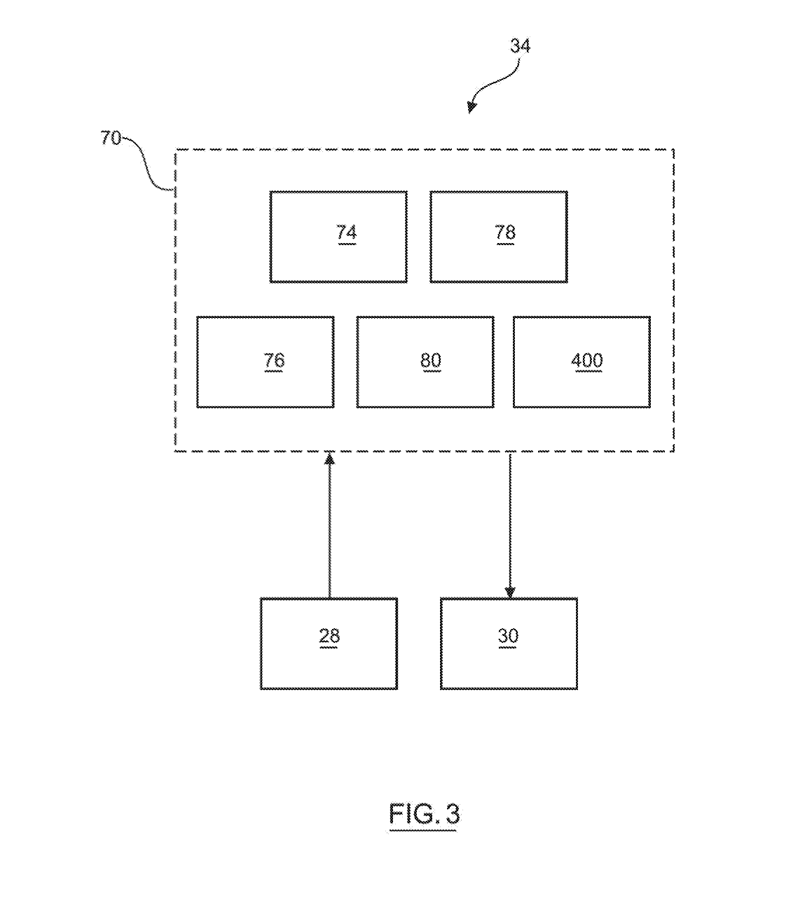

In accordance with various embodiments, the controller 34 implements an autonomous driving system (ADS) as shown in FIG. 3. That is, suitable software and/or hardware components of the controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, and the like) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, as discussed above with regard to FIG. 1, one or more instructions of the controller 34 are embodied in the target assessment system 100, for example for assessing a target vehicle in proximity to the vehicle 10 (e.g., as to whether the target vehicle is active or inactive), and taking appropriate action in response (e.g., by altering the path of the vehicle 10 accordingly based on the assessment). All or parts of the target assessment system 100 may be embodied in the computer vision system 74, and/or the vehicle control system 80 or may be implemented as a separate system (referred to as a target assessment system 400), as shown.

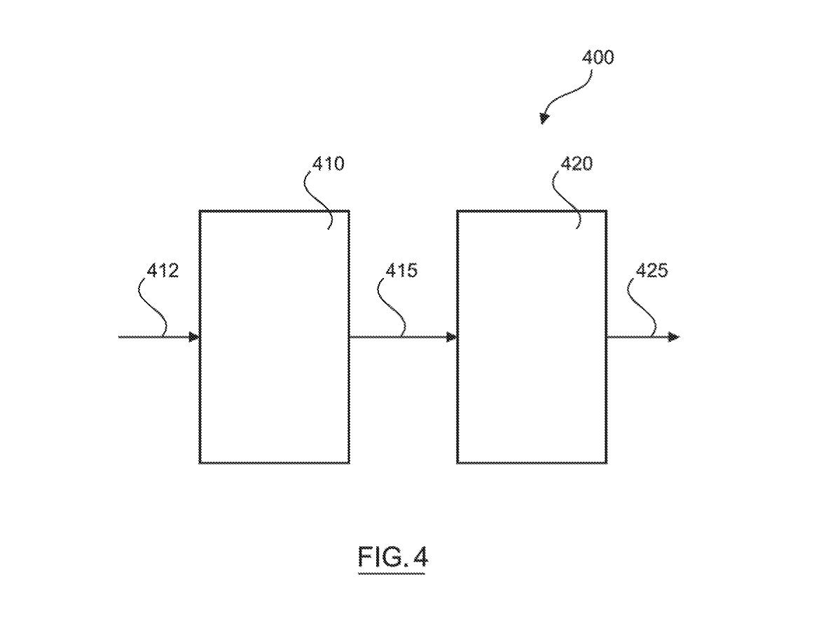

Referring to FIG. 4 and with continued reference to FIG. 1, the target assessment system 400 generally includes a detection module 410 and a processing module 420. In various embodiments, the detection module 410 and the processing module 420 are disposed onboard the vehicle 10. As can be appreciated, in various embodiments, parts of the target assessment system 400 may be disposed on a system remote from the vehicle 10 while other parts of the target assessment system 400 may be disposed on the vehicle 10.

In various embodiments, the detection module 410 receives sensor data 412 from various sensors 40a-40n of the vehicle 10 (e.g., lidar sensors, radar sensors, cameras, and so on). The detection module 410 gathers the sensor data 412 in order to obtain information pertaining to one or more target vehicles in proximity to the vehicle 10, as well as information pertaining to an environment surrounding the target vehicle. In various embodiments, the sensor data 412 is obtained via the sensors 40a-40n of FIG. 1. In various embodiments, the sensor data 412 may include, among other data, a type of vehicle for the target vehicle as well as information as to whether the target vehicle is moving, usage of the brakes for the target vehicle, use of signals (e.g., blinkers) for the target vehicle, a lane position of the target vehicle, a traffic intersection proximate the target vehicle, and one or more other vehicles in front of the target vehicle, among other possible information. In certain embodiments, the detection module 410 similarly obtains other data as part of the data 412, such as passenger inputs (e.g., as to a desired destination) and/or remote data from sources outside the vehicle 10 (e.g., from GPS systems, traffic providers, and so on). In various embodiments, the detection module 410 gathers this information and generates observational data 415 as outputs for the detection module 410, which are provided to the processing module 420 described below.

The processing module 420 receives the observational data 415 from the detection module 410, performs analysis using the received observational data 415 as to whether the target vehicle is active or inactive, and generates instructions 425 as appropriate for operation of the vehicle 10 in respect to the analysis. For example, in various embodiments, the processing module 420 utilizes a dynamic Bayesian network which uses the observational data 415 as inputs, or percepts, for use in determining whether the target vehicle is active or inactive. Also in various embodiments, the processing module 420 generates instructions 425 for operation of the vehicle 10 (e.g., for implementation via an automatic driving system, such as the ADS 70 of FIG. 3, and/or components thereof, and/or vehicle actuators, such as the actuators 42a . . . 42n of FIG. 1) in different manners based on whether the target vehicle is active or inactive. For example, in certain embodiments, the instructions 425 may be for the vehicle 10 to remain with a current path of travel if the target vehicle is active (e.g., if the target vehicle is currently being driven, is waiting at a traffic light, is in traffic, and so on), and to change the current path to drive around the target vehicle if the target vehicle is inactive (e.g., when the target vehicle is parked by the side of the road or in a parking lot, waiting at a bus stop, stopped to make a delivery, double parked, and so on).

Turning now to FIG. 5, a schematic diagram is provided of the autonomous vehicle 10 in a particular environment in proximity to a target vehicle 510, in accordance with various embodiments. As depicted in FIG. 5, in various embodiments the vehicle 10 is operating during a current vehicle ride along a roadway 500. In the depicted example, the roadway 500 includes two lanes 502, 504, with the vehicle 10 currently operating in current lane 504. Also as depicted in FIG. 5, the target vehicle 510 is disposed at least partially in the same lane 504 as the vehicle 10 in certain embodiments, such that the target vehicle 510 may potentially impede the path of the vehicle 10. Also as depicted in FIG. 5, one or more additional vehicles (e.g., a lead vehicle 512 in front of the target vehicle 510) may also be present along the roadway in various embodiments. Also as depicted in FIG. 5, in various embodiments the target vehicle 510 may also be near an intersection 514 (e.g., in certain examples, including a traffic light 516), for example with additional lanes 518, 520 in a different direction than (e.g., in one example, perpendicular to) lanes 502, 504.

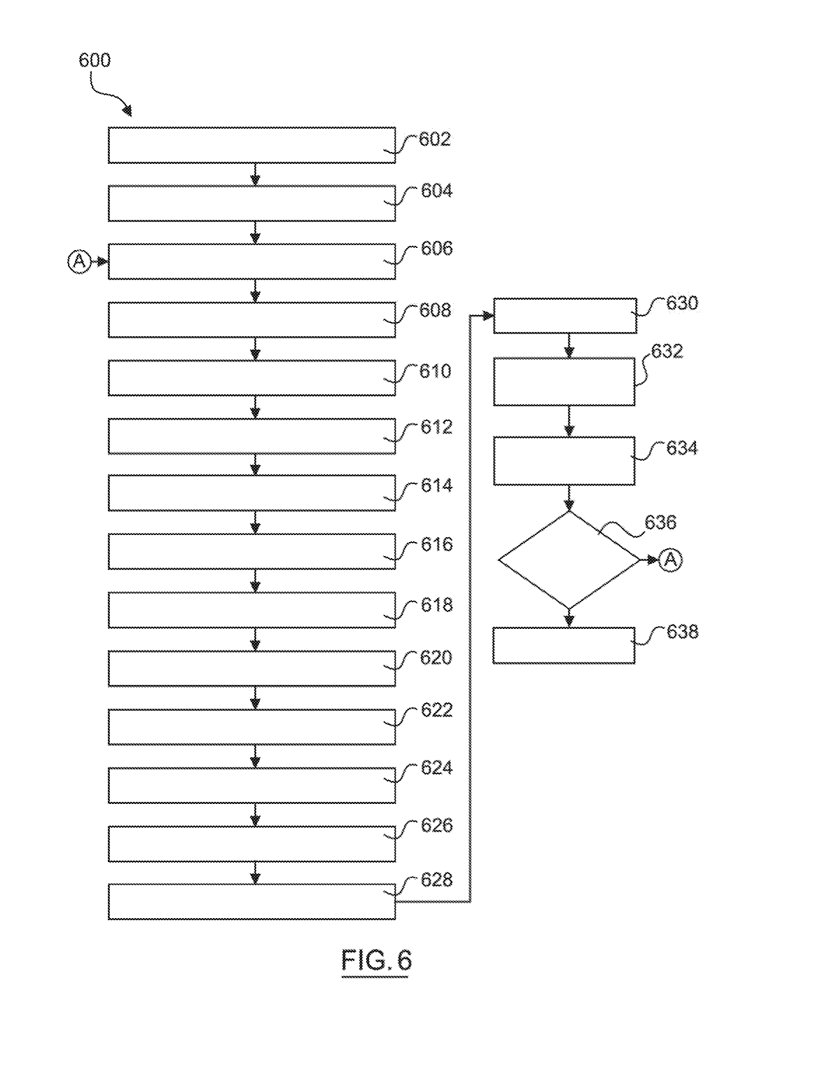

As will be set forth in greater detail below with respect to the control process 600 of FIG. 6, in various embodiments the vehicle 10 may respond differently based on a determination as to whether the target vehicle 510 is active or inactive. For example, in various embodiments, the vehicle 10 determines whether the target vehicle 510 is active using a dynamic Bayesian network, using observed data values pertaining to the target vehicle 510 and it surroundings (e.g., also pertaining to the lead vehicle 512, the intersection 514, and so on). Also in various embodiments, the vehicle 10 may change its path to maneuver around the target vehicle 510 is inactive, but not if the target vehicle 510 is active, among other possible responses.

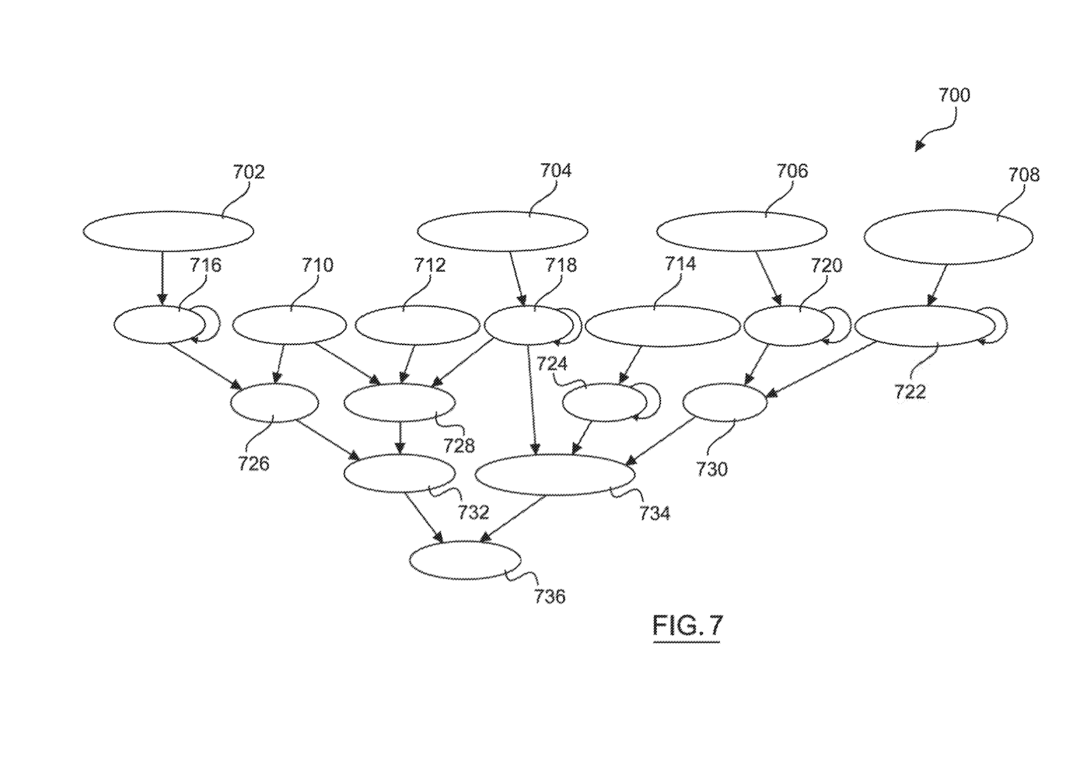

With reference to FIG. 6, a flowchart is provided for a control process 600 for assessing target vehicles in proximity to a vehicle, and for taking appropriate responses based on the assessment. In accordance with various embodiments, the control process 600 can be implemented in connection with the target assessment system 100 and vehicle 10 of FIG. 1, the transportation system 52 of FIG. 2, the autonomous driving system of FIG. 3, the target assessment system 400 of FIG. 4, and the implementation of FIG. 5, in accordance with various embodiments. Also in various embodiments, the control process 600 is also described below in connection with the dynamic Bayesian dynamic network 700 depicted in FIG. 7 and described further below in connection therewith.

The control process 600, and the various methods and systems discussed in this Application and implemented in connection therewith, utilize a Bayesian dynamic network in various embodiments. The Bayesian dynamic network is discussed in detail below in accordance with various embodiments. It will be appreciated that in certain other embodiments, the various methods (including the control process 600) and systems discussed in this Application may be implemented in any number of different types of classification systems. For example, in certain embodiments, the classification system(s) may include any number of different types of mathematical classification systems, and/or combinations thereof, including machine learning, forest tree, fuzzy logic, and/or number of other different types of algorithms, networks, systems, and/or techniques, instead of or in addition to a Bayesian dynamic network.

As can be appreciated in light of the disclosure, the order of operation within the control process 600 is not limited to the sequential execution as illustrated in FIG. 6, but may be performed in one or more varying orders as applicable and in accordance with the present disclosure. In various embodiments, the control process 600 can be scheduled to run based on one or more predetermined events, and/or can run continuously during operation of the vehicle 10.

In various embodiments, the control process 600 may begin at 602. In various embodiments, process step 602 occurs when an occupant is within the vehicle 10 and the vehicle 10 begins operation in an automated or non-automated manner.

Passenger inputs are obtained at 604. In various embodiments, the passenger inputs pertain to a desired destination for travel via the vehicle 10. In various embodiments, the user inputs may be obtained via an input device of the vehicle (e.g., corresponding to the input device 27 of FIG. 1) and/or a passenger device (e.g., the user device 54 of FIG. 2). Also in certain embodiments, the passenger inputs are obtained via the detection module 410 of FIG. 4.

Sensor data is obtained at 606. In various embodiments, sensor data is obtained from the various sensors 40a . . . 40n of FIG. 1. For example, in various embodiments, sensor data is obtained from cameras and/or other visions systems, lidar sensors, radar sensors, and/or one or more other sensors 40a . . . 40n of FIG. 1. Also in various embodiments, the sensor data may pertain to data observations pertaining to surroundings for the vehicle 10 as it travels along a roadway (e.g., roadway 500 of FIG. 5), including information as to other vehicles that may be in proximity to the vehicle 10, along with information as to a surrounding roadway, any surrounding intersections, and the like. Also in certain embodiments, the sensor data of 606 is obtained via the detection module 410 of FIG. 4 as sensor data 412 of FIG. 4, and corresponding outputs are provided as observational data 415 to the processing module 420 for processing.

Map data is obtained at 608. In various embodiments, map data is retrieved from a memory, such as the data storage devices 32 and/or 46 of FIG. 1, onboard the vehicle 10. In certain embodiments, the map data may be retrieved from the route database 53 of the autonomous vehicle based remote transportation system 52 of FIG. 2. Also in various embodiments, the map data comprises maps and associated data pertaining to roadways that are near the vehicle 10 and/or that are near or on the way from the vehicle 10's current to its destination (e.g., per the passenger inputs). Also in certain embodiments, the map data is obtained via the detection module 410 of FIG. 4.

In various embodiments, other data is obtained at 610. In various embodiments, the other data is obtained at 610 via the communication system 36 of FIG. 1 (e.g., from a transceiver thereof) from or utilizing one or more remote data sources. By way of example, in certain embodiments, the other data of 610 may include GPS data using one or more GPS satellites, including the present location of the vehicle 10; data regarding applicable traffic flows and patterns for the roadways, traffic light histories, histories of movement of nearby stationary vehicles, and/or weather, construction, and/or other data from one or more remote sources that may have an impact on the analysis of the target vehicle. In various embodiments, passengers of the vehicle 10 may also provide information as to the nearby vehicles and/or their surroundings, for example via the input device 27 of FIG. 1 and/or the user device 54 of FIG. 2. Also in certain embodiments, the other data is obtained via the detection module 410 of FIG. 4.

A path for the autonomous vehicle is planned and implemented at 612. In various embodiments, the path is generated and implemented via the ADS 70 of FIG. 3 for the vehicle 10 of FIG. 1 to reach a requested destination, using the passenger inputs of 604 and the map data of 608, for example via automated instructions provided by the processor 44 of FIG. 1. In various embodiments, the path of 612 comprises a path of movement of the vehicle 10 that would be expected to facilitate movement of the vehicle 10 to the intended destination while maximizing an associated score and/or desired criteria (e.g., minimizing driving time, maximizing safety and comfort, and so on). It will be appreciated that in various embodiments the path may also incorporate other data, for example such as the sensor data of 606 and/or the other data of 610. Also in certain embodiments, the path is planned via the processing module 420 of FIG. 4 (e.g., via the processor 44 of FIG. 1) and is implemented using instructions provided by the processing module 420 (e.g., via the processor 44).

A current location of the vehicle is determined at 614. In various embodiments, the current location is determined by the processing module 420 of FIG. 4 (e.g., using processor 44 of FIG. 1) using information obtained from 604, 608, 606 and/or 610. For example, in certain embodiments, the current location is determined using a GPS and/or other location system, and/or is received from such system. In certain other embodiments, the location may be determined using other sensor data from the vehicle and/or via inputs provided by a user or passenger of the vehicle 10.

An identification is made at 616 as to another vehicle that is disposed in proximity to the vehicle 10. In various embodiments, the processor 44 of FIG. 1 identifies a vehicle (hereafter also referred to as a “target vehicle”) that may potentially interfere with travel of the vehicle 10 along its current path of 612. In various embodiments, the target vehicle comprises a vehicle (such as target vehicle 510 of FIG. 5) that is stopped within or proximate the same lane (e.g. lane 504 of FIG. 5) as the vehicle 10, and/or that is stopped within or proximate the current path of the vehicle 10 (e.g., within a predetermined threshold distance and/or time of the vehicle 10's current path, such that contact would be likely if the target vehicle were to remain stopped and the vehicle 10 were to maintain its current path without stopping). In various embodiments, the identification of 616 is made by the processing module 420 of FIG. 4 (e.g., via the processor 44 of FIG. 1) using the observational data 415 from the detection module 410 from 606.

In various embodiments, percept information is obtained for a dynamic Bayesian network at 618. In various embodiments, the percept information pertains to data observations as to a target vehicle that is detected in proximity to the vehicle 10 (e.g., the target vehicle 510 of FIG. 5, in various embodiments), along with observed information as to a surrounding environment for the target vehicle. For example, in various embodiments, the percept information includes information as to the type of target vehicle, operational characteristics of the target vehicle, and other surrounding vehicles, roadways, intersections, and the like in proximity to the target vehicle. Also in various embodiments, the percept information is obtained from the sensor data of 606 that was obtained via the detection module 410 of FIG. 1 (e.g., via the sensors 40a . . . 40n of FIG. 1).

The percept information of 618 is used for a dynamic Bayesian network, such as the dynamic Bayesian network 700 depicted in FIG. 7. The dynamic Bayesian network 700 of FIG. 7 will now be described below, along with continued reference to 618 and the other steps of the control process 600 of FIG. 6.

With reference to FIG. 7, a dynamic Bayesian network 700 is provided for use in connection with the control process 600 of FIG. 6. As depicted in FIG. 7, the dynamic Bayesian network 700 includes various nodes 702-736. In various embodiments, nodes 702-734 are used to determine an activity state 736 of the target vehicle. In addition, in various embodiments, the nodes 702-736 are updated using simple rules of probability, in particular the law of total probability, namely: p(A)=p(A|B)p(B)+p(A|˜B)p(˜B).

In various embodiments, the activity state 736 refers to whether the target vehicle (e.g., the target vehicle 510 of FIG. 5) is active or inactive. In various embodiments, the target vehicle is considered to be “active” if the target vehicle is actively attempting to travel someplace, for example if the target vehicle is currently being driven, is waiting at a traffic light, is in traffic, and so on. Also in various embodiments, the target vehicle is considered to be “inactive” if the target vehicle is actively attempting to travel someplace, for example if the target vehicle is parked by the side of the road or in a parking lot, waiting at a bus stop, stopped to make a delivery, double parked, and so on).

In various embodiments, the activity state 736 is determined based on observed data and relationships between nodes 702-734. For example, in various embodiments, the activity state 736 is determined using respective distributions for the nodes that include conditional probabilities between the nodes. In various embodiments, the nodes 702-734 include percept nodes 702-714, dynamic nodes 716-724, and intermediate nodes 726-734.

In various embodiments, the percept nodes 702-714 (which also may be referred to as parent nodes or root nodes) represent a first layer of data that is directly observed via the sensors. In various embodiments, the percept nodes 702-714 include (i) an observed lead car 702 (e.g., the lead vehicle 512 of FIG. 5, in certain embodiments) in front of the target vehicle; (ii) an observed signal state 704 regarding use or nonuse of blinkers, hazard lights, turn indicators, and/or other signals for the target vehicle; (iii) an observed vehicle type 706 for the target vehicle (e.g., as to whether the target vehicle is an automobile, bus, truck, motorcycle, and/or other vehicle, and/or as to a particular make and/or model of the target vehicle, in certain embodiments); (iv) an observed movement state 708 as to whether or not the target vehicle is currently moving; (v) an intersection 710 in proximity to the target vehicle (e.g., that may include a traffic light, stop sign, crosswalk, and/or other reason for the target vehicle to stop, and for example corresponding to the intersection 514 of FIG. 5 in certain embodiments); (vi) a lane position 712 of the target vehicle (e.g., corresponding to lane 502 of FIG. 5 in certain embodiments); and (vii) an observed braking state 714 of the target vehicle (e.g., in certain embodiments, whether the braking system of the target vehicle is currently being utilized). In certain embodiments, additional and/or different percept nodes may also be utilized.

Also in various embodiments, the dynamic nodes 716-724 represent nodes that depend on an earlier state of the represented parameter. In various embodiments, the dynamic nodes 716-724 include: (i) a dynamic lead car state 716, (ii) a dynamic signal state 718, (iii) a dynamic vehicle type 720, (iv) a dynamic movement state 722, and (v) a dynamic braking state 724. In various embodiments, (i) the dynamic lead car state 716 depends on a previous value of the dynamic lead car state 716 as well as the observed lead car 702 (e.g., identifying position and/or movement of a third vehicle that is in front of the target vehicle); (ii) the dynamic signal state 718 depends on a previous value of the dynamic signal state 718 and the observed signal state 704; (iii) the dynamic vehicle type 720 depends on a previous value of the dynamic vehicle type 720 and the observed vehicle type 706, (iv) the dynamic movement state 722 depends on a previous value of the dynamic movement state 722 and the observed movement state 708; and (v) the dynamic braking state 724 depends on a previous value of the dynamic braking state 724 and the observed braking state 714. In certain embodiments, additional and/or different dynamic nodes may also be utilized.

Also in various embodiments, the intermediate nodes 726-734 represent nodes that depend on one or more different parameters represented by one or more percept nodes 702-714 and/or dynamic nodes 716-724. In various embodiments, the intermediate nodes 726-734 include: (i) a blocked state 726 representing whether the target vehicle is blocked from movement; (ii) a pulled over state 728 representing whether the target vehicle is pulled over (e.g., in certain embodiments, along the roadway); (iii) a motion state 730 pertaining to motion of the target vehicle (e.g., as to a magnitude and direction of movement of the target vehicle, in certain embodiments); (iv) a passable state 732 (e.g., as to whether the vehicle 10 is able to successfully maneuver around the target vehicle, in certain embodiments); and (vi) an apparent activity state 734 (e.g., as to an indication of whether the target vehicle is active or inactive). In certain embodiments, additional and/or different intermediate nodes may also be utilized.

With reference back to FIG. 6, in various embodiments, at 618, the generated percept nodes correspond to the percept nodes 702-714 of FIG. 7. In various embodiments, the sensor data (e.g., from the sensors 40a . . . 40n of FIG. 1) is utilized by the detection module 410 of FIG. 4 to populate initial, observed values for the various percept nodes 702-714 of FIG. 7. Specifically, in various embodiments, at 618, the sensor data is utilized to generate observed values, for the dynamic Bayesian network 700 of FIG. 7, for the observed lead car 702, the observed signal state 704, the observed vehicle type 706, the observed movement state 708, the intersection 710, the lane position 712, and the observed braking state 714 for the target vehicle.

With continued reference to FIG. 6, in various embodiments, distributions are assigned for the various percept nodes at 620. Specifically, in various embodiments, conditional probability distributions are assigned for the percept nodes 702-714 of FIG. 7 with respect to each of the nodes underneath the respective percept nodes 702-714 of FIG. 7 (e.g., with respect to nodes 716-734). In certain embodiments, the distributions are propagated directly, for example from vision systems (e.g. of the sensors 40a . . . 40n of FIG. 1) and/or other sensors and/or systems that provide probabilistic outputs. In certain other embodiments, the distributions are assigned by setting values explicitly from one or more systems, for example including GPS and/or map information. In various embodiments, the distributions are assigned via the processing module 420 of FIG. 4 (e.g., via the processor 44 of FIG. 1).

Also in various embodiments, dynamic parent values are generated at 622. In various embodiments, initial values for the dynamic nodes 716-724 (namely, the dynamic lead car state 716, the dynamic signal state 718, the dynamic vehicle type 720, the dynamic movement state 722, and the dynamic braking state 724) are generated at 622 based on previous sensor data obtained via the detection module 410 of FIG. 4 (e.g., via the sensors 40a . . . 40n of FIG. 1) with respect to a prior point in time (e.g., a previous iteration of 606, 618, and/or 622, in various embodiments). In various embodiments, the dynamic parent values are set equal to their previous respective values at 622. In various embodiments, the dynamic parent values are generated via the processing module 420 of FIG. 4 (e.g., via the processor 44 of FIG. 1).

Also in various embodiments, child distributions are generated at 624. In various embodiments, at 624, distributions are generated for the dynamic nodes 716-724 and the intermediate nodes 726-734 of FIG. 7, based on the distributions and observed values of the respective parent nodes. In various embodiments, the child distributions are assigned via the processing module 420 of FIG. 4 (e.g., via the processor 44 of FIG. 1).

For example, in various embodiments, the distributions of each of the dynamic nodes 716-724 are generated based on observed values of respective parent nodes 702-714 along with previous values of the dynamic nodes 716-724 themselves. Specifically, in various embodiments: (i) the distribution for the dynamic lead car state 716 is generated based on a previous dynamic lead car state 716 value and a current observed lead car 702 value and its parent distribution; (ii) the distribution for the dynamic signal state 718 is generated based on a previous dynamic signal state 718 values and a current observed signal state 704 value and its parent distribution; (iii) the distribution for the dynamic vehicle type state 720 is generated based on a previous dynamic vehicle type state 720 and a current observed vehicle type 706 value and its parent distribution; (iv) the distribution for the dynamic movement state 722 is generated based on a previous dynamic movement state 722 and a current observed movement state 708 value and its parent distribution; and (v) the distribution for the dynamic braking state 724 is generated based on a previous dynamic braking state 724 and a current observed braking state 714 value and its parent distribution.

By way of additional example, in various embodiments, the distributions of each of the intermediate nodes 726-734 are generated based on observed values and/or distributions of respective parent nodes 702-714, dynamic nodes 716-724, and/or other intermediate nodes that are above (i.e., that are parent nodes) for each particular intermediate node in question for which the child distribution is being calculated. Specifically, in various embodiments: (i) the distribution for the blocked state 726 is determined based on the current dynamic lead vehicle state 716 and the current observed intersection state 710 and their respective distributions; (ii) the distribution for the pulled over state 728 is determined based on the current observed intersection state 710, the current observed lane position state 712, and the current dynamic signal state 718 and their respective distributions; (iii) the distribution for the motion state 730 is determined based on the current dynamic vehicle type state 720 and the current dynamic movement state 722 and their respective distributions; (iv) the distribution of the passable state 732 is determined based on the blocked state 726 and the pulled over state 728 and their respective distributions; (v) the distribution of the apparent activity state 734 is determined based on the current dynamic signal state 718, the current dynamic braking state 724, and the motion state 730 and their respective distributions; and (vi) the distribution of the activity state 736 is based on the passable state 732 and the apparent activity state 734 and their respective distributions.

In various embodiments, the dynamic distributions are saved at 626 for use in one or more subsequent iterations. Specifically, in various embodiments, the dynamic distributions for dynamic nodes 716-724 are stored in memory, such as storage devices 32 and/or 46 of FIG. 1, for use in determining respective current dynamic values for 716-724 in a subsequent iteration.

The target vehicle status is determined at 628. In various embodiments, the status (e.g., active or inactive) of the target vehicle is determined as the current value of the activity status node 736 of FIG. 7. Also in various embodiments, the current value of the activity status node 736 is determined based on the observed values and distributions of the various nodes 702-734 of the dynamic Bayesian network 700 of FIG. 1, working from top to bottom down the dynamic Bayesian network from the percept nodes 702-714, down through the dynamic nodes 716-724, down through the intermediate nodes 726-734, and ultimately down to the activity status node 736. In various embodiments, these determinations are made via the processing module 420 of FIG. 4 (e.g., via the processor 44 of FIG. 1).

In various embodiments, the target vehicle status is reported at 630. In various embodiments, the status of the target vehicle (as active or inactive) is reported to one or more passengers of the vehicle 10 (e.g., on a display screen and/or via audio output, and/or via the user device 54 of FIG. 2) and/or to one or more other persons and/or entities (e.g., to one or more other vehicles, and/or to a remote operator, central server, or the like) via the communication system 36 (e.g., via one or more transceivers thereof). Also in various embodiments, the target vehicle status is reported via instructions provided via the processing module 420 (e.g., via a processor 44 of FIG. 4) via instructions 425 of FIG. 4.

In various embodiments, responses are provided as appropriate at 632 based on the target vehicle status. For example, in certain embodiments, the vehicle 10 may change its path of movement (e.g., of 612, above) in order to maneuver around the target vehicle if the target vehicle is inactive (e.g., because the target vehicle may not be expected to move out of the path of the vehicle 10 in the near future when the target vehicle is inactive). Also by way of example, also in certain embodiments, the vehicle 10 may maintain its current path of movement (e.g., of 612, above, because the target vehicle may be expected to move out of the path of the vehicle 10 in the near future when the target vehicle is active). Also in various embodiments, the response, if any, is determined via the processing module 420 of FIG. 4 (e.g., via a processor 44 of FIG. 1), and is implemented via instructions 425 of FIG. 4. Also in various embodiments, the instructions are implemented via an automatic driving system (such as the ADS 70 of FIG. 3, and/or components thereof, and/or vehicle actuators, such as the actuators 42a . . . 42n of FIG. 1) that executes instructions provided by the processing module 420 of FIG. 4 (e.g., via the processor 44 of FIG. 1).

In various embodiments, the vehicle 10 continues traveling at 634. For example, in certain embodiments, the vehicle 10 continues to travel (i) along its original path of 612, if the target vehicle is active; or (ii) along its amended path of 632, if the target vehicle is inactive. Also in various embodiments, the continued travel is directed by the processing module 420 of FIG. 4 (e.g., via a processor 44 of FIG. 1), and is implemented via instructions 425 of FIG. 4 that are executed via an automatic driving system (such as the ADS 70 of FIG. 3, and/or components thereof, and/or vehicle actuators, such as the actuators 42a . . . 42n of FIG. 1).

In various embodiments, as the vehicle 10 continues to travel, determinations are made at various iterations of 636 as to whether vehicle 10 has reached its destination. For example, in various embodiments, the processing module 420 of FIG. 4 (e.g., using a processor 44 of FIG. 4, and based on data provided by a navigation system of the vehicle 10) whether the vehicle 10 has reached a destination that was previously inputted or requested by an occupant of the vehicle 10.

In various embodiments, if the vehicle 10 has not reached its destination, then the process returns to 606, as the vehicle 10 continues to travel. In various embodiments, the process then repeats, beginning with 606, as additional sensor data is collected, along with the successive steps of the control process 600, until the vehicle 10 has reached its destination. Also in various embodiments, once the vehicle 10 has reached its destination, the process terminates at 638.

In various embodiments, the disclosed methods and systems provide for an assessment of target vehicles that may be in proximity to a vehicle, such as an autonomous vehicle. For example, in various embodiments, sensor data is used in connection with a dynamic Bayesian network to ascertain whether the target vehicle is active or inactive. Also in various embodiments, a response (such as maneuvering around the target vehicle) is provided based on whether the target vehicle is active or inactive.

As mentioned briefly, the various modules and systems described above may be implemented as one or more machine learning models that undergo supervised, unsupervised, semi-supervised, or reinforcement learning. Such models might be trained to perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), and linear discriminant analysis models.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for assessing a target vehicle in proximity to a host vehicle, the method comprising:
detecting the target vehicle in proximity to the host vehicle;
obtaining sensor data, from one or more sensors onboard the host vehicle, pertaining to one or more characteristics of the target vehicle; and
assessing a state of the target vehicle, via a processor, via a dynamic Bayesian network, using the sensor data as inputs for the dynamic Bayesian network.

2. The method of claim 1, wherein the step of assessing the state of the target vehicle comprises assessing the state of the target vehicle as active or inactive based on a dynamic Bayesian network, using the sensor data in the dynamic Bayesian network, wherein the state of the target vehicle is characterized as:
active, if the target vehicle is attempting to travel to a location; and
inactive, if the target vehicle is not attempting to travel to a location.

3. The method of claim 1, wherein each of the steps is performed as part of operation of an autonomous vehicle.

4. The method of claim 1, wherein the step of assessing the state of the target vehicle comprises assessing a state of the target vehicle, via a processor, via the dynamic Bayesian network that includes a plurality of percept nodes, a plurality of dynamic nodes, a plurality of intermediate nodes, and an activity node representing the state of the target vehicle, using the sensor data as inputs for the dynamic Bayesian network.

5. The method of claim 4, wherein the step of assessing the state of the target vehicle comprises:
generating percept values for the percept nodes pertaining to observed values for the sensor data;
determining distributions for each of the nodes, the distribution for each respective node comprising one or more conditional probabilities for the respective node in relation to one or more other nodes of the dynamic Bayesian network pertaining to the sensor data; and
assessing the state of the target vehicle using the percept values and the distributions.

6. The method of claim 5, wherein the percept values are generated based on one or more probabilistic measures provided via one or more sensors of the host vehicle.

7. The method of claim 5, wherein the step of assessing the target vehicle further comprises:
assigning current dynamic values based at least in part on respective prior dynamic values and respective percept values;
wherein the step of determining distributions comprises, for at least some of the nodes, determining the distributions based also at least in part on the current dynamic values.

8. A system for assessing a target vehicle in proximity to a host vehicle, the system comprising:
a detection module configured to at least facilitate:
detecting the target vehicle in proximity to the host vehicle; and
obtaining sensor data, from one or more sensors onboard the host vehicle, pertaining to one or more characteristics of the target vehicle; and
a processing module coupled to the detection module and configured to, by a processor, at least facilitate assessing a state of the target vehicle via a dynamic Bayesian network, using the sensor data as inputs for the dynamic Bayesian network.

9. The system of claim 8, wherein the processing module is configured to at least facilitate characterizing the state of the target vehicle, using the sensor data and the dynamic Bayesian network, as:
active, if the target vehicle is attempting to travel to a location; and
inactive, if the target vehicle is not attempting to travel to a location.

10. The system of claim 8, wherein the system is implemented as part of an autonomous vehicle.

11. The system of claim 8, wherein the dynamic Bayesian network includes a plurality of percept nodes, a plurality of dynamic nodes, a plurality of intermediate nodes, and an activity node representing the state of the target vehicle.

12. The system of claim 11, wherein the processing module is configured to at least facilitate:
generating percept values for the percept nodes pertaining to observed values for the sensor data;
determining distributions for each of the nodes, the distribution for each respective node comprising one or more conditional probabilities for the respective node in relation to one or more other nodes of the dynamic Bayesian network pertaining to the sensor data; and
assessing the state of the target vehicle using the percept values and the distributions.

13. The system of claim 12, wherein the processing module is configured to at least facilitate generating the percept values based on one or more probabilistic measures provided via one or more sensors of the host vehicle.

14. The system of claim 12, wherein the processing module is configured to at least facilitate:
assigning current dynamic values based at least in part on respective prior dynamic values and respective percept values; and
determining the distributions, for at least one of the nodes, based also at least in part on the current dynamic values.

15. An autonomous vehicle comprising:
an autonomous drive system configured to operate the autonomous vehicle based on instructions that are based at least in part on a state of a target vehicle in proximity to the autonomous vehicle;
a plurality of sensors configured to obtain sensor data pertaining to one or more characteristics of a target vehicle in proximity to the autonomous vehicle; and
a processor coupled to the plurality of the sensors and to the autonomous drive system, the processor configured to at least facilitate:
assessing a state of the target vehicle via a dynamic Bayesian network, using the sensor data as inputs for the dynamic Bayesian network; and
providing the instructions to the autonomous drive system based at least in part on the assessed state of the target vehicle.

16. The autonomous vehicle of claim 15, wherein the processor is configured to at least facilitate characterizing the state of the target vehicle, using the sensor data and the dynamic Bayesian network, as:
active, if the target vehicle is attempting to travel to a location; and
inactive, if the target vehicle is not attempting to travel to a location.

17. The autonomous vehicle of claim 15, wherein the dynamic Bayesian network includes a plurality of percept nodes, a plurality of dynamic nodes, a plurality of intermediate nodes, and an activity node representing the state of the target vehicle.

18. The autonomous vehicle of claim 17, wherein the processor is configured to at least facilitate:
generating percept values for the percept nodes pertaining to observed values for the sensor data;
determining distributions for each of the nodes, the distribution for each respective node comprising one or more conditional probabilities for the respective node in relation to one or more other nodes of the dynamic Bayesian network pertaining to the sensor data; and
assessing the state of the target vehicle using the percept values and the distributions.

19. The autonomous vehicle of claim 17, wherein the processor is configured to at least facilitate generating the percept values based on one or more probabilistic measures provided via one or more sensors of the host vehicle.

20. The autonomous vehicle of claim 17, wherein the processor is configured to at least facilitate:
assigning current dynamic values based at least in part on respective prior dynamic values and respective percept values; and
determining the distributions, for at least one of the nodes, based also at least in part on the current dynamic values.
